(19) United States
(12) Patent Application Publication
(10) Pub. No.: US 2019/0113350 A1
(43) Pub. Date: Apr. 18, 2019

(54) ROUTE-PLANNING METHOD AND NAVIGATIONAL SYSTEM OF CONVERTING ROUTE DESCRIPTION INTO MACHINE-READABLE PREDEFINED ROUTE

(71) Applicant: MITAC INTERNATIONAL CORP., Taoyuan City (TW)

(72) Inventors: Nhon Ngu, San Dimas, CA (US); Viktor Kunitsyn, San Dimas, CA (US)

(21) Appl. No.: 15/782,825

(22) Filed: Oct. 12, 2017

(51) Int. Cl. G01C 21/34; G06F 17/30

(52) U.S. Cl. CPC G01C 21/3415; G06F 17/30241; G01C 21/3446

(57) ABSTRACT

A route-planning method and a navigational system of converting a route description into a machine-readable predefined route are provided. Keywords in the route description are identified and one or multiple maneuvers are extracted from the route description in a spreadsheet format based on the keywords. The spreadsheet format includes a plurality of columns and rows associated with a current location, a starting point, an ending point, a total distance and a type of the maneuver. A tree of possible routes in the machine-readable format is created based on a mapping database. Each route contains the one or multiple maneuvers. The machine-readable format contains a plurality of via-point coordinates associated with each segment in the one or multiple maneuvers according to the mapping database. A most appropriate route is selected from the tree of possible routes as the machine-readable pre-defined route using a ranking algorithm.

### BACKGROUND OF THE INVENTION

### 1. Field of the Invention

The present invention is related to a route-planning method and a navigational system of converting a route description into a machine-readable format, more particularly, to a route-planning method and a navigational system of converting a route description into a machine-readable format for RTR services.

### 2. Description of the Prior Art

In “Return-to-route (RTR)” business, drivers go on pre-defined routes with designated stops, and it is important that a single stop is never missed regardless of the road conditions. If the driver somehow deviates from the current route segment, navigation is required to re-route him back to the point from which the route was deviated so that upcoming stops will not be skipped.

In many RTR services, the pre-defined routes may be changed on a daily basis or per request. Normally, the pre-defined routes are drafted in a paper or spreadsheet with human readable description. Such text description cannot be understood by standard navigation engines which receive data in a strict format. Also, there may be errors or inaccuracies in the spreadsheet which may cause problems in subsequent RTR navigation.

Therefore, there is a need for a method and a navigational system of converting informal route description into machine-readable formats for RTR services.

### SUMMARY OF THE INVENTION

The present invention provides a route-planning method of converting a route description into a machine-readable format. The method includes identifying keywords in the route description, extracting one or multiple maneuvers from the route description in a spreadsheet format based on the keywords, creating a tree of possible routes in a machine-readable format based on a mapping database, and selecting a most appropriate route from the tree of possible routes using a ranking algorithm. Each route in the tree of possible routes contains the one or multiple maneuvers. The spreadsheet format includes a plurality of columns and rows, wherein a first column among the plurality of columns is associated with a current location of a maneuver, a second column among the plurality of columns is associated with a starting point of the maneuver, a third column among the plurality of columns is associated with an ending point of the maneuver, a fourth column among the plurality of columns is associated with a total distance of the maneuver, and a fifth column among the plurality of columns is associated with a type of the maneuver. The machine-readable format contains a plurality of via-point coordinates associated with each segment in the one or multiple maneuvers according to the mapping database.

The present invention provides a navigational system which includes an input receiving unit configured to receive a route description, a mapping database configured to store geographic data, road network data and keyword data, an identifying unit configured to identify keywords in the route description, and a processing unit. The processing unit is configured to extract one or multiple maneuvers from the route description in a spreadsheet format based on the keywords, create a tree of possible routes in a machine-readable format based on a mapping database, and select a most appropriate route from the tree of possible routes using a ranking algorithm. The one of more maneuvers include detailed instructions provided for reaching a desired destination. Each route in the tree of possible routes contains the one or multiple maneuvers. The spreadsheet format includes a plurality of columns and rows, wherein a first column among the plurality of columns is associated with a current location of a maneuver, a second column among the plurality of columns is associated with a starting point of the maneuver, a third column among the plurality of columns is associated with an ending point of the maneuver, a fourth column among the plurality of columns is associated with a total distance of the maneuver, and a fifth column among the plurality of columns is associated with a type of the maneuver. The machine-readable format contains a plurality of via-point coordinates associated with each segment in the one or multiple maneuvers according to the mapping database.

The present invention also provides a method for converting a route description into a machine-readable format, applicable to route-planning for a navigation device. The method includes identifying keywords in the route description, extracting one or multiple maneuvers from the route description in a human-readable format based on the keywords, creating a tree of possible routes in a machine-readable format based on a mapping database, selecting a most appropriate route with filled-in via-points to form a continuous route from the tree of possible routes in the machine-readable format using a ranking algorithm, and producing a file in the machine-readable format which includes via-points, segments and turn direction. The human-readable format including a first entry, a second entry, a third entry and a fourth entry representing a maneuver associated with a first road intersected with a second road and a third road, wherein the first entry indicates a first intersection point of the first road and the second road, the second entry indicates a second intersection point of the first road and the third road, the third entry indicates a distance between the first intersection point and the second intersection point, and the fourth entry indicates a turn direction on the first road. Each route in the tree of possible routes includes the one or multiple maneuvers, which are converted into a plurality of via-point coordinates associated with segments defined in the one or multiple maneuvers according to the mapping database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method of converting a route description into a machine-readable format for an RTR navigational system according to an embodiment of the present invention.

FIG. 2 is a diagram of an RTR navigational system for implementing the method depicted in FIG. 1 according to an embodiment of the present invention.

FIG. 3 is a table illustrating the spreadsheet format as an Microsoft Excel format according to an embodiment of the present application.

FIG. 4 is a diagram illustrating the extracted one or multiple maneuvers in the spreadsheet format on a map according to an embodiment of the present application.

### DETAILED DESCRIPTION

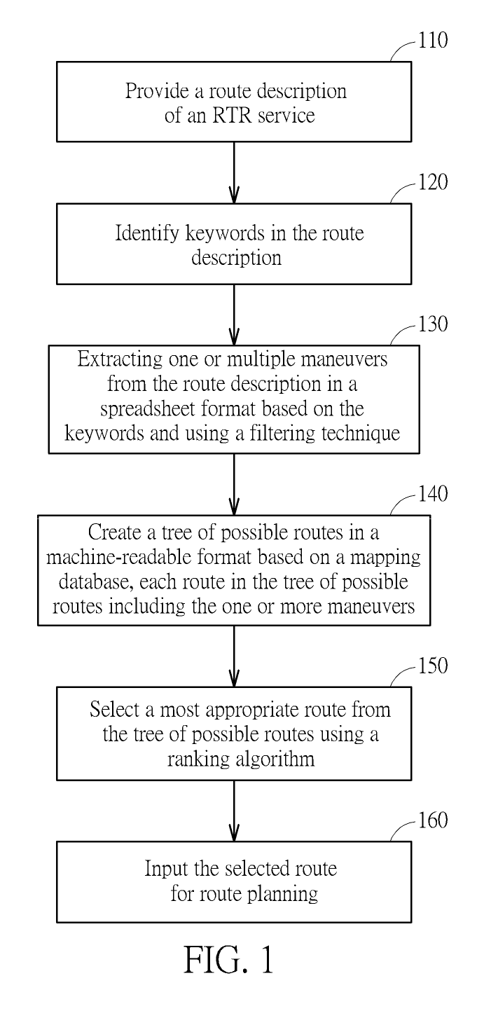

FIG. 1 is a flowchart illustrating a method of converting a route description into a machine-readable format for an RTR navigational system according to an embodiment of the present invention.

Step 110: provide a route description of an RTR service; execute step 120.

Step 120: identify keywords in the route description; execute 130.

Step 130: extracting one or multiple maneuvers from the route description in a human-readable spreadsheet format based on the keywords and using a filtering technique; execute step 140.

Step 140: creating a tree of possible routes in a machine-readable format based on a mapping database, each route in the tree of possible routes including the one or multiple maneuvers; execute step 150.

Step 150: select a most appropriate route from the tree of possible routes using a ranking algorithm; execute step 160.

Step 160: input the selected route for route planning.

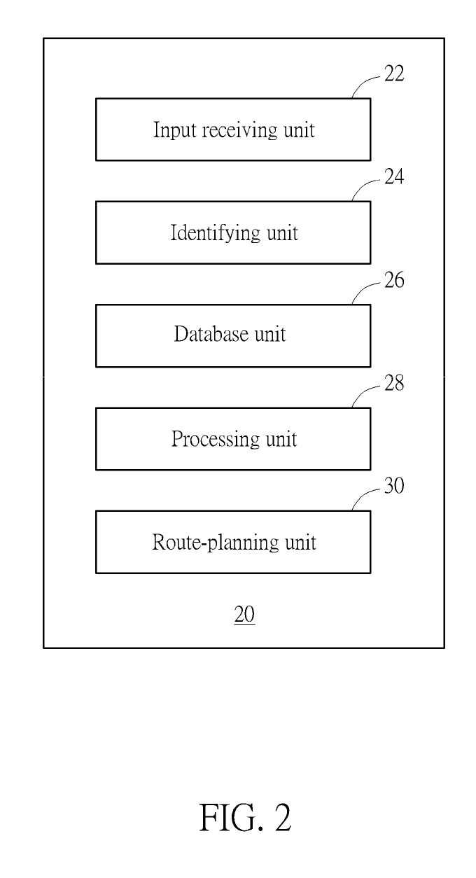

FIG. 2 is a diagram of an RTR navigational system 20 for implementing the method depicted in FIG. 1 according to an embodiment of the present invention. The RTR navigational system 20 includes an input receiving unit 22, an identifying unit 24, a mapping database 26, a processing unit 28, and a route-planning unit 30.

In RTR business such as school and public transport buses, sanitation disposal services, pickup and delivery services, and snowplows, it is essential that drivers make every stop regardless of road conditions. The pre-defined routes for such RTR services are normally drafted in a paper or spreadsheet with human readable description. In step 110, the route description of the RTR service may be provided to the RTR navigational system 20 via the input receiving unit 22.

In an embodiment, the input receiving unit 22 may be incorporated with a user interface for allowing the route description of the RTR service to be typed in with its original text format. In another embodiment, the input receiving unit 22 may be incorporated with a phonetic interface, such as based on Soundex, Daitch-Mokotoff Soundex, Metaphone, or Double Metaphone technique, for allowing the user to narrate the route description of the RTR service. However, the method of providing the route description of the RTR service to the RTR navigational system 20 does not limit the scope of the present invention.

The route description provided in step 110 may include informal descriptions such as “move forward by Main St from intersection with Over Ct to intersection with High Dr, then make left turn on High Dr” or “make left turn back into dead end. Not only is such informal route description incomprehensible to machines, it may not be accurate due to errors in the original spreadsheet or typing/oral mistakes made in step 110.

In step 120, keywords in the route description may be identified using the identifying unit 24 according to the mapping database 26. The mapping database 26 may include a geographic database, a road network database, and a keyword database. The keyword database may store common maneuver terms and roadway terms which are mostly represented by abbreviations in the transportation system. Table 1 illustrates the full name and abbreviations of some common roadway terms.

TABLE 1

| Type | Abbreviation | Type | Abbreviation |
|---|---|---|---|
| Road | Rd. | Runs | Run |
| Street | St. | Place | Pl. |
| Avenue | Ave. | Bay | Bay |
| Boulevard | Blvd. | Crescent | Cres. |
| Lane | Ln. | Highway | Hwy |
| Drive | Dr. | Interstate | I |
| Way | Way | Turnpike | Tpke. |
| Court | Ct. | Freeway | Fwy |
| Plaza | Plz | Parkway | Pkwy |
| Square | Sq. | Causeway | Cswy |
| Terrace | Ter. | Driveway | Drwy |

In the route description, the word that comes before an abbreviation of a roadway term is most likely its name. Terms such as “on”, “from”, “to”, “right”, “left” and “straight” are related to the type of maneuvers. Terms such as “miles”, “feet”, “kilometers” and “meters” are related to travel distance. In the present invention, the identifying unit 24 is configured to identify all essential information associated with each maneuver segment in the route description according to information stored in the database unit 26.

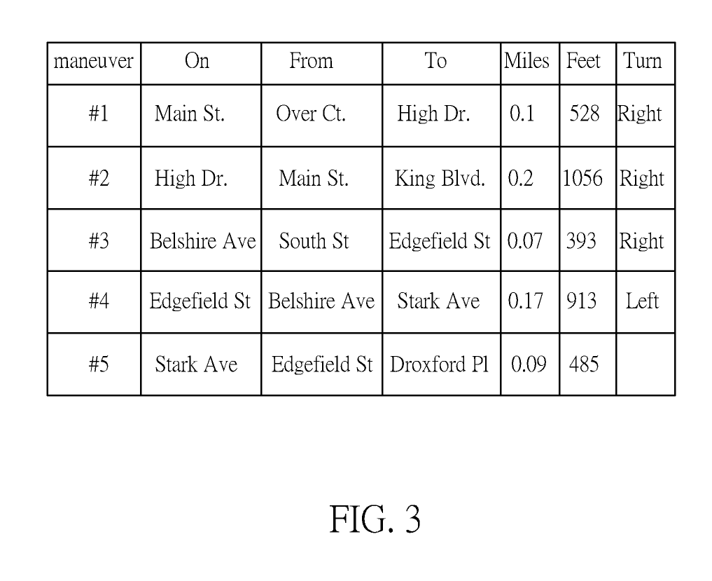

In step 130, the processing unit 28 is configured to extract one or multiple maneuvers from the route description in a spreadsheet format based on the keywords identified in step 120. FIG. 3 is a diagram illustrating the extracted one or multiple maneuvers in the spreadsheet format according to an embodiment of the present application. In this embodiment, the spreadsheet format may be a Microsoft Excel format (xls) table in a strict format of columns and rows. For illustrative purpose, it is assumed that 5 mandatory maneuvers #1˜#5 may be extracted from the route description. However, the number of the extracted maneuvers does not limit the scope of the present invention.

The value of the “On” column represents the current location of the maneuver. The value of the “From” column represents the starting point of the maneuver. The value of the “To” column represents the ending point of the maneuver. The values of the “Miles” column and the “Feet” column represent the total distance of the maneuver. The value of the “Turn” column represents the type of the maneuver. Each row corresponds to a related maneuver.

For example, the informal description of a maneuver “move forward by Main St from intersection with Over Ct to intersection with High Dr, then make left turn on High Dr” in the spreadsheet may be transformed into a machine readable format, as indicated by maneuver #1 in FIG. 3. More specifically, maneuver #1 in FIG. 3 is interpreted by a standard navigation engine as a maneuver which occurs on the Main St. (as indicated by the value of the “On” column) , starts from the intersection of the Main St. and the Over Ct. (as indicated by the value of the “From” column), continues 0.1 mile or 528 feet on the Main St (as indicated by the values of the “Mile” column and the “Feet” column), arrives at High Dr. (as indicated by the value of the “To” column), and then makes a left turn (as indicated by the value of the “Turn” column).

Duplicate or similar sounding street names may exist in the same region. People may also informally use the term “road” as a synonym of the term “street” regardless of the most common definition. In order to accurately represent each maneuver segment in the route description of the RTR service, the processing unit 28 may also be implemented with a fuzzy street name comparison technique in step 130 in order to filter out remote locations/streets which may be unreliable data caused by inaccurate information in the route description.

In order to handle cases in which the spreadsheet contains incorrect data, any unreasonable information of the route description may be filtered out according to the mapping database 26 in step 130. For example, if the route description includes a maneuver of “straight on Main Str. for 1 mile and turn right on Church Rd”, but there is no Church Rd. intersecting Main Str. according to the mapping database 26, the above-mentioned maneuver will be removed.

In order to handle cases in which the spreadsheet contains inaccurate maneuver distance, the processing unit 28 may also introduce a distance threshold T in step 130. If the maneuver distance of a specific segment is D according to the mapping database 26, an interval (D−T, D+T) is adopted in step 130 when the processing unit 28 extracts the one or multiple maneuvers from the route description in the spreadsheet format. More specifically, if the keyword associated with the maneuver distance of a specific segment identified from the input route description is D′, the processing unit 28 is configured to remove the specific segment from the spreadsheet format when D′ is smaller than (D−T) or is larger than (D+T). In the present invention, the value of the distance threshold T may be derived empirically and adjusted in order to include more street/segment candidates so that the content of the spreadsheet format can be closer to the original input spreadsheet, or to include fewer street/segment candidates so as to provide more reliable content of the spreadsheet format. However, the value of the distance threshold T does not limit the scope of the present invention.

Sometimes the input spreadsheet may contain “holes”. A hole is the part of the maneuver going on a street whose name does not match the value of the “On” column. In response, the present invention may also introduce a maximum hole size H. The processing unit 28 is configured to remove any segment whose hole size is larger than H from the spreadsheet format in step 130. In the present invention, the value of the maximum hole size H may be derived empirically and adjusted in order to include more street/segment candidates so that the content of the spreadsheet format can be closer to the original input spreadsheet, or to include fewer street/segment candidates so as to provide more reliable content of the spreadsheet format. However, the value of the maximum hole size H does not limit the scope of the present invention.

The present method may also take traffic restriction into account. More specifically, the processing unit 28 is configured to remove a specific segment from the spreadsheet format in step 130 if the specific segment violates local traffic rules.

Sometimes the input spreadsheet may contain wrong maneuver directions. For example, if the route description includes a maneuver of “straight on Main Str. for 0.1 mile and turn right on Church Rd.”, but the Church Rd. is one the left side of the Main Str. according to the mapping database 26, the above-mentioned maneuver direction “turn right” will be removed.

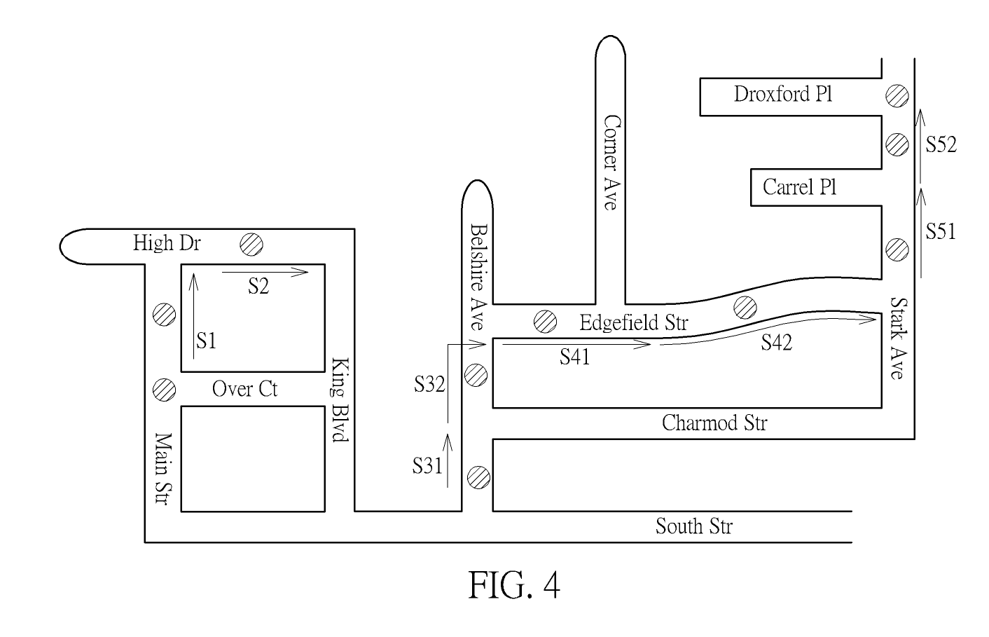

FIG. 4 is a diagram illustrating the extracted one or multiple maneuvers in the spreadsheet format on a map according to an embodiment of the present application. Referring to FIGS. 3 and 4, it is assumed that 5 mandatory maneuvers #1˜#5 may be extracted from the route description. Each mandatory maneuver may contain one or multiple segments, each of which is defined as a part of a street between crossroads. More specifically, maneuver #1 contains one segment S1, maneuver #2 contains one segment S2, maneuver #3 contains two segment S31˜S32, maneuver #4 contains two segment S41˜S42, and maneuver #5 contains two segment S51˜S52.

For each segment in the mandatory maneuvers #1˜#5, a via-point may be used to identify the middle of the segment. Also, additional via-points may be used to identify the start and the end of a route. The above-mentioned via-points are represented by striped dots in FIG. 4.

As can be seen in FIG. 4, the extracted one or multiple maneuvers in the spreadsheet format contain all mandatory maneuvers indicated in the route description of the RTR service. These mandatory maneuver segments may be connected to each other (such as #1 and #2), or are separate segments (such as #2 and #3).

In step 140, the tree of possible routes in the machine-readable format is created based on the geographic/road network information stored in the mapping database 26. Each route in the tree of possible routes contains all of the extracted one or multiple maneuvers. In an embodiment, the machine-readable format is an Extensible Markup Language (XML) format received by most routing application programming interfaces (API) and algorithms.

In the tree of possible routes in XML format according to an embodiment of the present invention, the contents of most elements may be extracted from the tree of possible routes in xls format and modified according to the mapping database 26. All segments of a driving maneuver not disclosed in the xls format may be inserted in the XML format according to the mapping database 26. For example, a plurality of via-point coordinates associated with each segment in the one or multiple maneuvers may be inserted for each maneuver in the tree of possible routes in XML format according to the mapping database. As a result, the segments in the tree of possible routes in XML format sequentially form continuous routes for adjacent maneuvers in the spreadsheet format. Some remarks may also be added to those inserted segments so as to differentiate from the mandatory segments indicated in the input spreadsheet.

In some RTR business, it is only essential that drivers make every stop, but alternative routes may be taken between these designated stops. However, in an embodiment when the route description of the RTR service provided in step 110 is for snowplow, the assigned route needs to be traveled from the start point to the end point of each segment of assigned route in a designated sequence. Under such circumstance, a plurality of points of all segments in the assigned route are defined in the sequence as indicated in the route description of the RTR service, wherein two consecutive points form a segment. Therefore, a plurality of the above-mentioned via-segments associated with the one or multiple segments of the assigned route maybe inserted in the tree of possible routes in XML format according to the mapping database.

In step 150, the processing unit 28 may select the most appropriate route from the tree of possible routes using any known ranking algorithm for multipath source routing. For instance, a ranking coefficient may be calculated for each possible route in the tree based on maneuver distance, energy, delay and reliability. The route with the highest ranking coefficient is then selected as the most appropriate route. However, the type of ranking algorithm does not limit the scope of the present invention.

In step 160, the selected route may be inputted to the route-planning unit 30 for providing RTR navigation. As previously stated, the most appropriate route selected in step 150 contains all the mandatory maneuvers indicated in the route description. The route-planning unit 30 is configured to provide navigation from its current location to the first maneuvers of the selected route and then follow the selected route.

In an embodiment when the selected route includes dead ends or roads of narrow width or tight turning radius, the mandatory maneuvers may not be all connected in the selected route. Under such circumstance, the route-planning unit 30 is configured to provide navigation further using its own routing engine so as to connect all the mandatory maneuvers in the selected route.

In another embodiment, the vehicle may deviate from the predefined route when the driver decides to visit a petrol station. Under such circumstance, the route-planning unit 30 is configured to resume the navigation service based on its new location and the rest of non-visited mandatory maneuvers in the selected route.

The present invention provides a method and a navigational system capable of converting informal route description into a machine-readable format. In RTR business such as school and public transport buses, sanitation disposal services, pickup and delivery services, and snowplows, the pre-defined routes drafted in a service spreadsheet can be accurately inputted to navigation application so that the vehicle does not miss any section.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A route-planning method which converts a route description into a machine-readable format, comprising:
identifying keywords in the route description;
extracting one or multiple maneuvers from the route description in a spreadsheet format based on the keywords, wherein:
the spreadsheet format includes a plurality of columns and rows;
a first column among the plurality of columns is associated with a current location of a maneuver;
a second column among the plurality of columns is associated with a starting point of the maneuver;
a third column among the plurality of columns is associated with an ending point of the maneuver;
a fourth column among the plurality of columns is associated with a total distance of the maneuver; and
a fifth column among the plurality of columns is associated with a type of the maneuver;
creating a tree of possible routes in a machine-readable format based on a mapping database, wherein:
each route in the tree of possible routes includes the one or multiple maneuvers; and
the machine-readable format contains a plurality of via-point coordinates associated with each segment in the one or multiple maneuvers according to the mapping database; and
selecting a most appropriate route from the tree of possible routes in the machine-readable format using a ranking algorithm.

2. The route-planning method of claim 1, further comprising:
removing an extracted maneuver when the extracted maneuver contains inconsistent information with respect to data of the mapping database.

3. The route-planning method of claim 1, further comprising:
identifying the keywords in the route description by identifying an abbreviation of a roadway term, a term related to a maneuver type, or a term related to a travel distance in the route description.

4. The route-planning method of claim 1, further comprising:
extracting the one or multiple maneuvers from the route description in the spreadsheet format based on the keywords using a fuzzy street name comparison technique.

5. The route-planning method of claim 1, further comprising:
deciding a value T of a distance threshold;
acquiring a maneuver distance D′ of a first maneuver segment identified in the route description
acquiring a maneuver distance D of the first maneuver segment from the mapping database;
removing the first segment from the spreadsheet format when D′ is smaller than (D−T) or is larger than (D+T).

6. The route-planning method of claim 1, further comprising:
removing a second maneuver segment from the spreadsheet format when the second maneuver segment violates a traffic rule.

7. The route-planning method of claim 1, further comprising:
inputting the selected most appropriate route in to a navigational system for route planning.

8. A navigational system, comprising:
an input receiving unit configured to receive a route description;
a mapping database configured to store geographic data, road network data and keyword data;
an identifying unit configured to identify keywords in the route description;
a processing unit configured to:
extract one or multiple maneuvers from the route description in a spreadsheet format based on the keywords, wherein:
the spreadsheet format includes a plurality of columns and rows;
a first column among the plurality of columns is associated with a current location of a maneuver;
a second column among the plurality of columns is associated with a starting point of the maneuver;
a third column among the plurality of columns is associated with an ending point of the maneuver;
a fourth column among the plurality of columns is associated with a total distance of the maneuver; and
a fifth column among the plurality of columns is associated with a type of the maneuver;
create a tree of possible routes in a machine-readable format based on the mapping database, wherein:
each route in the tree of possible routes includes the one or multiple maneuvers; and
the machine-readable format contains a plurality of via-point coordinates associated with each segment in the one or multiple maneuvers according to the mapping database; and
select a most appropriate route from the tree of possible routes using a ranking algorithm.

9. The navigational system of claim 8, wherein the identifying unit is further configured to identify the keywords in the route description by identifying an abbreviation of a roadway term, a term related to a maneuver type, or a term related to a travel distance in the route description.

10. The navigational system of claim 8, wherein the processing unit is further configured to extract the one or multiple maneuvers from the route description in the spreadsheet format based on the keywords using a fuzzy street name comparison technique.

11. The navigational system of claim 8, wherein the processing unit is further configured to:
decide a value T of a distance threshold;
acquire a maneuver distance D′ of a first maneuver segment identified in the route description
acquire a maneuver distance D of the first maneuver segment from the mapping database; and
remove the first segment from the spreadsheet format when D′ is smaller than (D−T) or is larger than (D+T).

12. The navigational system of claim 8, wherein the processing unit is further configured to remove a second maneuver segment from the spreadsheet format when the second maneuver segment violates a traffic rule.

13. The navigational system of claim 8, further comprising a routing engine configured to perform route planning based on the selected most appropriate route.

14. A method for converting a route description into a machine-readable format, applicable to route-planning for a navigation device, comprising:
identifying keywords in the route description;
extracting one or multiple maneuvers from the route description in a human-readable format based on the keywords, the human-readable format including a first entry, a second entry, a third entry and a fourth entry representing a maneuver associated with a first road intersected with a second road and a third road, wherein:
the first entry indicates a first intersection point of the first road and the second road;
the second entry indicates a second intersection point of the first road and the third road;
the third entry indicates a distance between the first intersection point and the second intersection point; and
the fourth entry indicates a turn direction on the first road;
creating a tree of possible routes in a machine-readable format based on a mapping database, wherein:
each route in the tree of possible routes includes the one or multiple maneuvers, which are converted into a plurality of via-point coordinates associated with segments defined in the one or multiple maneuvers according to the mapping database;
selecting a most appropriate route with filled-in via-points to form a continuous route from the tree of possible routes in the machine-readable format using a ranking algorithm; and
producing a file in the machine-readable format which includes via-points, segments and turn directions.

15. The method of claim 14, further comprising:
removing an extracted maneuver when the extracted maneuver contains inconsistent information with respect to data of the mapping database.

16. The method of claim 14, further comprising:
extracting the one or multiple maneuvers from the route description based on the keywords using a fuzzy street name comparison technique.

17. The method of claim 14, further comprising:
deciding a value T of a distance threshold;
acquiring a maneuver distance D′ of a first maneuver segment identified in the route description
acquiring a maneuver distance D of the first maneuver segment from the mapping database;
removing the first segment as converted into the machine readable format from the human-readable format when D′ is smaller than (D−T) or is larger than (D+T).

18. The method of claim 14, further comprising:
removing a second maneuver segment as converted into the machine readable format from the human-readable format when the second maneuver segment violates a traffic rule.

19. The method of claim 14, further comprising:
removing a direction defined in a third maneuver as converted into the machine readable format from the human-readable format when a plurality of via-point coordinates defined in a fourth maneuver are not on a same side indicated by the direction, wherein the fourth maneuver is subsequent to the third maneuver.

20. The route-planning method of claim 14, further comprising:
removing filled-in via-points or directions by the navigation device; and
recalculating a new route to exclude the filled-in via-points.
